(19) United States
(12) Patent Application Publication
(10) Pub. No.: US 2019/0302849 A1
(43) Pub. Date: Oct. 3, 2019

(54) CURVED DISPLAY

(71) Applicant: KORTEK CORPORATION, INCHEON (KR)

(72) Inventor: KYOUNG CHAN LEE, SEOUL (KR)

(21) Appl. No.: 16/315,889

(22) PCT Filed: Jul. 12, 2017
(86) PCT No.: PCT/KR2017/007433

§ 371 Date: Jan. 7, 2019

(30) Foreign Application Priority Data
Jul. 12, 2016 (KR) 10-2016-0087989

(51) Int. Cl. G06F 1/16; G09F 9/30

(52) U.S. Cl. CPC G06F 1/1652; G09F 9/301

(57) ABSTRACT

A curved display is provided. The curved display includes: a glass part; a panel part supporting the edges of the glass part; a fixed bracket located between the glass part and the panel part and fixed to the glass part; an extension member extended from the fixed bracket and facing the panel part; and a fixing member for fixing the extension member to the panel part.

### CROSS-REFERENCE TO RELATED APPLICATIONS

This application claims priority to PCT Application No. PCT/KR2017/007433, having a filing date of Jul. 12, 2017, based on KR 10-2016-0087989, having a filing date of Jul. 12, 2016, the entire contents both of which are hereby incorporated by reference.

### FIELD OF TECHNOLOGY

The following relates to a curved display, and more particularly, to a curved display capable of facilitating attachment and detachment of curved glass.

### BACKGROUND

Generally, display devices have progressed into a form in which they are light but may become larger, and a form of displays has progressed to have a flatter panel and a wider viewing angle such that it is possible to display a higher quality image than the past.

In a flat panel display, an RGB image is received from an external system and is processed in an internal controller to be converted to be suitable for a display panel, and the converted RGB image is supplied to each sector of the display which is divided on a matrix in two dimensions according to timings of a gate driver and a source driver so that an image is displayed on a display surface.

However, in this case, since an eyeball, which is an organ with which a viewer senses an actual screen, has a spherical surface, when the viewer views the screen, a gap between a horopter surface, at which distances from the front of the screen toward both left and right sides are recognized as the same distances, and the display surface of the display gradually increases, and thus a problem occurs in that the realness of the recognized image is degraded even when the screen becomes larger.

In order to solve such a problem, a curved display with increased viewer immersion has been invented. However, a difficulty occurs in a task in which large-sized curved glass is attached and detached to and from a panel, and because of this, a problem occurs in that productivity is decreased. Therefore, there is a need to improve this.

The known art of the present invention has been disclosed in Korean Unexamined Patent Application Publication No. 2016-0030629 (Date of Publication: Mar. 21, 2016, Title of Invention: Curved display and image processing method thereof).

### SUMMARY

An aspect relates to a curved display capable of facilitating attachment and detachment of curved glass.

A curved display according to embodiments of the present invention includes a glass part, a panel part configured to support an edge of the glass part, a fixing bracket disposed between the glass part and the panel part and fixed to the glass part, an extension member configured to extend from the fixing bracket and face the panel part, and a fixing member configured to fix the extension member to the panel part.

The glass part may have a curved surface formed in a flat shape or a concave shape toward a front portion at which an image is displayed.

The panel part may include a panel support part configured to support the glass part and having a shape corresponding to the curved surface of the glass part, and a panel frame connected to the panel support part and having a side surface to which the extension member is fixed.

The fixing bracket may be formed in a plate shape and adhered to the glass part which faces the panel support part.

The extension member may be provided in plural in the fixing bracket and may extend in a bent shape from the fixing bracket to be in contact with the side surface of the panel frame.

The fixing member may pass through the extension member to be engaged with the panel frame.

In a curved display according to embodiments of the present invention, since a fixing bracket, which is disposed between a glass part and a panel part, is fixed to the glass part, and an extension member, which extends from the fixing bracket, is fixed by a fixing member while being in contact with the panel part, attachment and detachment of curved glass are easily performed so that time taken for maintenance and repair is saved.

### BRIEF DESCRIPTION

Some of the embodiments will be described in detail, with reference to the following figures, wherein like designations denote like members, wherein:

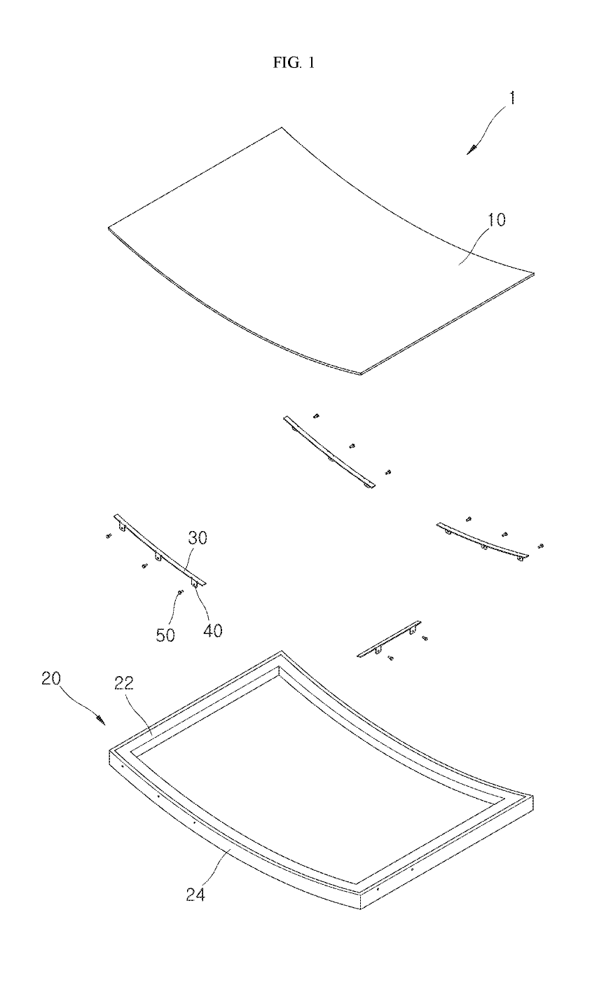

FIG. 1 is an exploded perspective view illustrating main configurations of a curved display according to an embodiment of the present invention-;

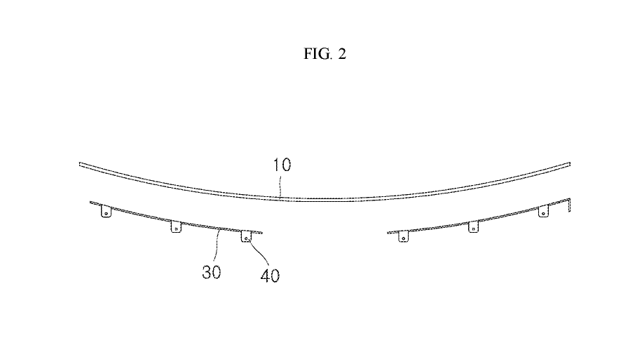

FIG. 2 is a front view illustrating a glass part, a fixing bracket, and an extension member according to an embodiment of the present invention-:

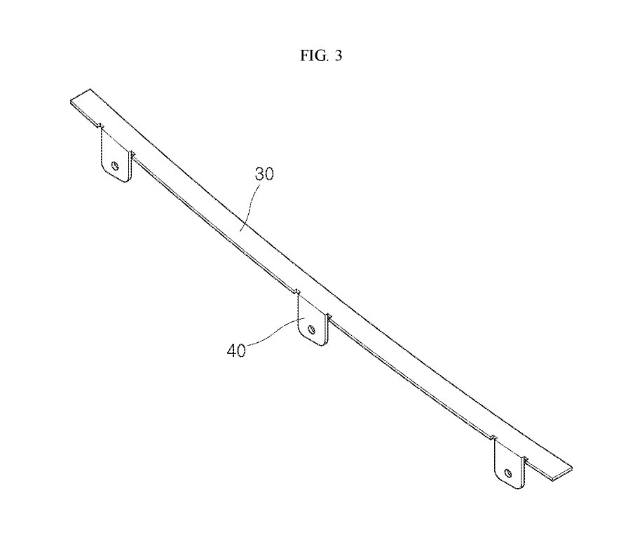

FIG. 3 is a perspective view illustrating the fixing bracket and the extension member according to an embodiment of the present invention-:

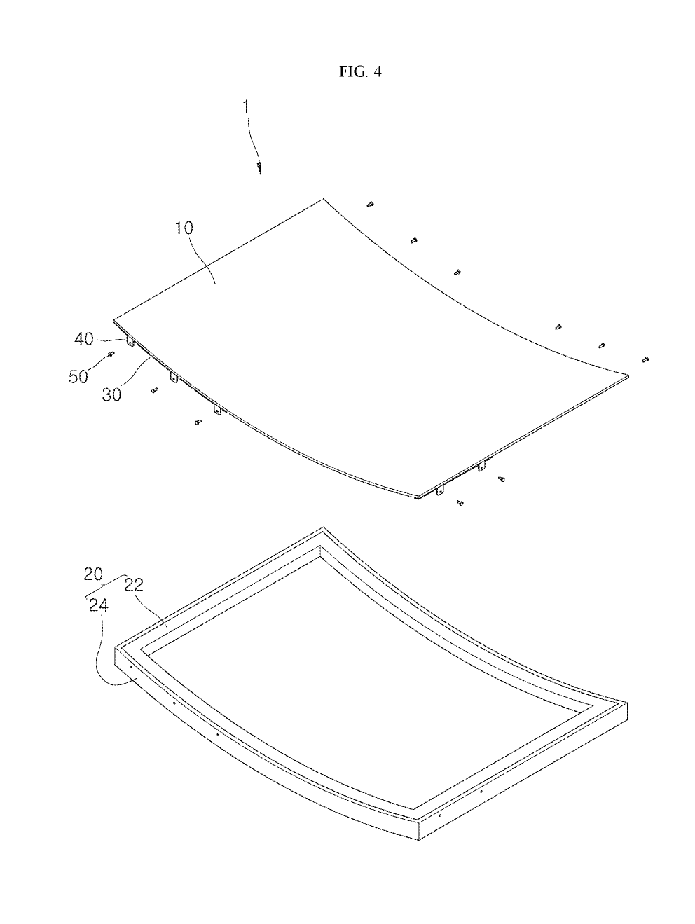

FIG. 4 is a perspective view illustrating a state in which the glass part is fixed to the panel support part according to an embodiment of the present invention; and

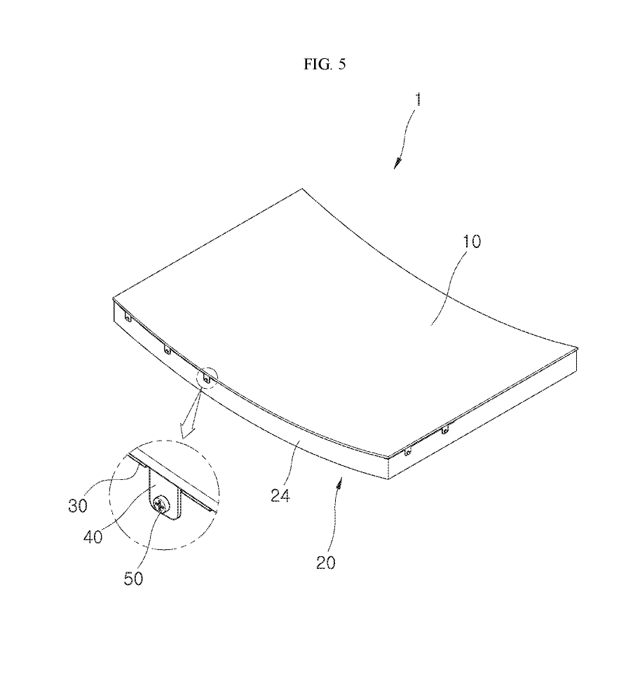

FIG. 5 is a perspective view illustrating an exterior of the curved display according to an embodiment of the present invention.

### DETAILED DESCRIPTION

Hereinafter, a curved display according to an embodiment of the present invention will be described with reference to the accompanying drawings. In this process, thicknesses of lines, sizes of elements, or the like illustrated in the drawings may have been exaggerated for clarity and convenience of description.

Terms which will be described below are terms defined in consideration of functions in embodiments of the present invention and may vary according to intensions or practices of a user or an operator. Therefore, such terms should be defined on the basis of content throughout the present specification.

FIG. 1 is an exploded perspective view illustrating main configurations of a curved display according to an embodiment of the present invention; FIG. 2 is a front view illustrating a glass part, a fixing bracket, and an extension member according to an embodiment of the present invention; FIG. 3 is a perspective view illustrating the fixing bracket and the extension member according to an embodiment of the present invention, FIG. 4 is a perspective view illustrating a state in which the glass part is fixed to the panel support part according to an embodiment of the present invention, and FIG. 5 is a perspective view illustrating an exterior of the curved display according to an embodiment of the present invention.

As illustrated in FIGS. 1 to 5, a curved display 1 according to an embodiment of the present invention includes a glass part 10, a panel part 20 configured to support an edge of the glass part 10, a fixing bracket 30 disposed between the glass part 10 and the panel part 20 and fixed to the glass part 10, an extension member 40 configured to extend from the fixing bracket 30 and face the panel part 20, and a fixing member 50 configured to fix the extension member 40 to the panel part 20.

The glass part 10 has a curved surface formed in a flat shape or a concave shape toward a front portion at which an image is displayed. The glass part 10 is a portion of the curved display 1 through which an image is transmitted and is formed in a curved shape in order to widen a viewing angle. The glass part 10 which is formed to have a predetermined curvature is bent in a concave shape in a direction toward a viewer. The glass part 10 may be formed in a bent shape or a flat shape and be transformed to various shapes as necessary.

The panel part 20 supports an edge of the glass part 10 and may be formed in various shapes within the technical idea in which the glass part 10 or the fixing bracket 30 fixed to the glass part 10 is mounted on the panel part 20. The panel part 20 according to an embodiment includes a panel support part 22 configured to support the glass part 10 and having a shape corresponding to the curved surface of the glass part 10, and a panel frame 24 connected to the panel support part 22 and having a side surface to which the extension member 40 is fixed.

The panel frame 24 may have the shape of a quadrilateral frame and have a curved surface, which corresponds to the glass part 10, formed as necessary. The panel support part 22 protrudes toward an inner side of the panel frame 24, and the panel support part 22 has a curved surface formed in the shape corresponding to the curved surface of the glass part 10.

The fixing bracket 30 is disposed between the glass part 10 and the panel part 20 and may be transformed to various shapes within the technical idea in which the fixing bracket 30 is fixed to the glass part 10. The fixing bracket 30 according to an embodiment is formed in a plate shape and is adhered to the glass part 10 which faces the panel support part 22.

The fixing bracket 30 is a rectangular plate. A strong adhesive is applied on the fixing bracket 30 which faces the glass part 10, and then the fixing bracket 30 is fixed to the glass part 10.

The extension member 40 extends from the fixing bracket 30 and is formed in a shape facing the panel part 20. The extension member 40 according to an embodiment is provided in plural in the fixing bracket 30 and extends in a bent shape from the fixing bracket 30 to be in contact with the side surface of the panel frame 24.

The extension member 40 is provided in a shape that is bent from the fixing bracket 30, and the fixing bracket 30 and the extension member 40 are integrally formed. The plurality of extension members 40 are spaced apart from each other at predetermined intervals along the fixing bracket 30, and the extension member 40 is provided at a position facing the panel part 20.

The fixing member 50 may include various types of fixing devices within the technical idea in which the fixing member 50 fixes the extension member 40 to the panel part 20. A bolt which passes through the extension member 40 to be engaged with the panel frame 24 is used as the fixing member 50 according to an embodiment.

Hereinafter, an assembly state of the curved display 1 according to an embodiment of the present invention will be described in detail with reference to the accompanying drawings.

The fixing bracket 30 is fixed to a rear surface of the glass part 10 which has a curved shape. In this case, any attachable adhesive material such as an adhesive or an ultraviolet (UV) hardener may be used. In this case, positions at which the fixing bracket 30 is provided, the number of fixing brackets 30, the shape of the fixing bracket 30, and the like may be set in consideration of the size, shape, and the like of the glass part.

The glass part 10 on which the fixing bracket 30 is mounted is seated on the panel support part 22 of the panel part 20, and then the extension member 40 is fixed to the panel frame 24 using the fixing member 50 while the extension member 40 is disposed at the side surface of the panel frame 24. Since the fixing member 50, which is screw-shaped, passes through the extension member 40 to be engaged with the panel frame 24, the extension member 40, the fixing bracket 30 connected to the extension member 40, and the glass part 10 fixed to the fixing bracket 30 are fixed to the panel part 20.

When the glass part 10 is damaged, maintenance and repair of the glass part 10 may be facilitated by separating the fixing member 50 from the panel part 20.

According to embodiments of the present invention, since, as described above, the fixing bracket 30 disposed between the glass part 10 and the panel part 20 is fixed to the glass part 10 and the extension member 40 which extends from the fixing bracket 30 is fixed by the fixing member 50 while being in contact with the panel part 20, attachment and detachment of curved glass are facilitated, and thus time taken for maintenance and repair may be saved.

Although the present invention has been disclosed in the form of preferred embodiments and variations thereon, it will be understood that numerous additional modifications and variations could be made thereto without departing from the scope of the invention.

For the sake of clarity, is to be understood that the use of “a” or “and” throughout this application does not exclude a plurality, and “comprising” does not exclude other steps or elements. The mention of a “unit” or a “module” does not preclude the use of more than one unit or module.

1. A curved display comprising:
a glass part;
a panel part configured to support an edge of the glass part;
a fixing bracket disposed between the glass part and the panel part and fixed to the glass part;
an extension member configured to extend from the fixing bracket and face the panel part; and
a fixing member configured to fix the extension member to the panel part.

2. The curved display of claim 1, wherein the glass part has a curved surface formed in a flat shape or a concave shape toward a front portion at which an image is displayed.

3. The curved display of claim 2, wherein the panel part comprises:
a panel support part configured to support the glass part and having a shape corresponding to the curved surface of the glass part; and
a panel frame connected to the panel support part and having a side surface to which the extension member is fixed.

4. The curved display of claim 3, wherein the fixing bracket is formed in a plate shape and adhered to the glass part which faces the panel support part.

5. The curved display of claim 4, wherein the extension member is provided in plural in the fixing bracket and extends in a bent shape from the fixing bracket to be in contact with the side surface of the panel frame.

6. The curved display of claim 5, wherein the fixing member passes through the extension member to be engaged with the panel frame.
